(19) United States
(12) Patent Application Publication
(10) Pub. No.: US 2025/0105420 A1
(43) Pub. Date: Mar. 27, 2025

(54) REINFORCEMENT APPARATUS FOR BATTERY SYSTEM

(71) Applicants: Hyundai Motor Company, Seoul (KR); Kia Corporation, Seoul (KR)

(72) Inventors: Gyung Hoon Shin, Seoul (KR); Eung Gyu Lee, Hwaseong-si (KR); Yong Hwan Choi, Seoul (KR); Hae Woong Jung, Anyang-si (KR)

(21) Appl. No.: 18/412,800

(22) Filed: Jan. 15, 2024

(30) Foreign Application Priority Data
Sep. 25, 2023 (KR) 10-2023-0128472

(51) Int. Cl. H01M 50/258; H01M 10/613; H01M 10/6556; H01M 50/204; H01M 50/264

(52) U.S. Cl. CPC H01M 50/258; H01M 10/613; H01M 10/6556; H01M 50/204; H01M 50/264

(57) ABSTRACT

An embodiment battery system reinforcement apparatus includes a case, a plurality of battery modules mounted in multiple stages in the case, a plurality of cooling blocks respectively attached to the battery modules and defining a cooling passage, and a support member disposed in contact with an outer side of the battery modules and connected to the battery modules or the cooling blocks to support the battery modules and the cooling blocks.

### CROSS-REFERENCE TO RELATED APPLICATIONS

This application claims the benefit of Korean Patent Application No. 10-2023-0128472, filed on Sep. 25, 2023, which application is hereby incorporated herein by reference.

### TECHNICAL FIELD

The present disclosure relates to a reinforcement apparatus for a battery system.

### BACKGROUND

Electrified vehicles that use electric motors to drive the vehicle, such as hybrid vehicles, fuel cell vehicles, and electric vehicles, are equipped with a high-voltage battery unit that stores driving power provided to the electric motors.

Typically, a high-voltage battery unit may include a case forming a sealed internal space for the battery, a battery module that contains a plurality of battery cells and is installed in the sealed internal space inside the case, and a battery management system (BMS) that monitors the voltage, current, and temperature of the battery cell inside the battery module and performs control for battery management according thereto.

Here, a cooling structure is applied to the battery module to maintain an appropriate temperature, and various cooling methods such as air cooling and water cooling are adopted.

In particular, as the recent battery system is based on a dedicated platform, the battery system is installed in the lower part of the vehicle.

However, in the case of a high-performance electric vehicle to secure a high-performance driver's seat, there are limitations in securing the overall height of the vehicle, which restricts installation of a battery system in the lower part of the vehicle.

Accordingly, a structure is required to enable installation of the battery system to a portion other than the lower part of the vehicle and effective cooling of the battery system.

To this end, although battery modules may be mounted in multiple stages, this may cause, if the stability of each battery module is not secured, problems in which the surface pressure of the battery cells is unable to be maintained.

The foregoing described as the background is intended merely to aid in the understanding of the background of embodiments of the present disclosure and is not intended to mean that the embodiments of the present disclosure fall within the purview of the related art already known to those skilled in the art.

### SUMMARY

The present disclosure relates to a reinforcement apparatus for a battery system. Particular embodiments relate to a battery system reinforcement apparatus that diversifies the installation location of a battery system by mounting battery modules and cooling blocks in multiple stages, increases structural rigidity by reinforcing overall rigidity, and ensures battery stability by maintaining surface pressure of battery cells.

Embodiments of the present disclosure an solve problems in the prior art, and a particular embodiment of the present disclosure provides a battery system reinforcement apparatus in which battery modules and cooling blocks are mounted in multiple stages, thereby diversifying the installation locations of the battery system, increasing structural rigidity by reinforcing overall rigidity, and ensuring battery stability by maintaining surface pressure of battery cells.

A battery system reinforcement apparatus according to embodiments of the present disclosure may include a case, a plurality of battery modules mounted in multiple stages in the case, a plurality of cooling blocks attached to the respective battery modules and forming a cooling passage, and a support member provided in contact with an outer side of the battery module and connected to the battery module or the cooling block to support the battery module and the cooling block.

The case may include a lower case and an upper case, the battery modules and the cooling blocks may be mounted in the lower case, and the upper case may be formed to cover the battery modules and the cooling blocks and may be coupled to the lower case.

The battery module may include a plurality of cells, and the plurality of cells may be stacked to be arranged in a transverse direction while standing in a longitudinal direction.

The case may include a front part and a rear part, and the front part and the rear part may be connected at right angles to form a T shape.

The cooling block may include a first cooling block provided in the front part of the case and a second cooling block provided in the rear part of the case, and the first cooling block and the second cooling block may share the cooling passage.

The battery system reinforcement apparatus may further include a cooling hose having an inlet and an outlet for circulation of the cooling medium.

The first cooling block may be connected to the inlet and the outlet of the cooling hose and include a first partition formed to divide the cooling passage into a cooling passage leading to the inlet and a cooling passage leading to the outlet, and a second partition may be formed in the second cooling block to be matched to the first partition such that the cooling medium flowing in from the first cooling block is guided by the second partition to circulate throughout the second cooling block.

The support member may include a longitudinal member and a transverse member, and the longitudinal member and the transverse member may be disposed to surround the outer side of the battery module.

The transverse member may extend in the lateral direction from an outer surface of the battery module and include a first fastening portion connected to the battery module and the cooling block.

The battery module may include a first connection portion formed on the outer surface thereof so as to match the first fastening portion, the cooling block may include a first coupling portion formed on the outer surface thereof so as to match the first fastening portion, and the first fastening portion of the transverse member, the first connection portion, and the first coupling portion may be coupled to each other through a fastening member while matching each other.

A plurality of first fastening portions, a plurality of first connection portions, and a plurality of first coupling portions may be configured to be spaced apart from each other at equal intervals.

The longitudinal member may be divided into a plurality of parts and formed to extend along the outer surface of the battery module in the longitudinal direction, and the respective longitudinal members may be connected to each other by a second fastening portion.

The cooling block may include a second coupling portion formed on the outer surface thereof so as to match the second fastening portion, and the second fastening portion of the longitudinal member and the second coupling portion may be coupled to each other through the fastening member while matching each other.

The second fastening portions may be formed at the upper and lower ends of the longitudinal member, respectively, and in the case of different support members provided on the upper and lower sides of the cooling block, the second fastening portions of each longitudinal member may be coupled to the second coupling portion of the cooling block through the fastening member.

The battery system reinforcement apparatus in the structure described above may have battery modules and cooling blocks mounted in multiple stages, thereby diversifying the installation locations of the battery system, increasing structural rigidity by reinforcing overall rigidity, and ensuring battery stability by maintaining surface pressure of battery cells.

Damage due to external loads such as vibration and compression applied to the battery module is prevented by ensuring the structural rigidity and coupling of the battery system as described above.

### BRIEF DESCRIPTION OF THE DRAWINGS

The above and other aspects, features, and advantages of embodiments of the present disclosure will be more apparent from the following detailed description taken in conjunction with the accompanying drawings, in which:

FIG. 1 is a diagram illustrating a battery system of embodiments of the present disclosure;

FIG. 2 is an internal diagram of a battery system of embodiments of the present disclosure;

FIG. 3 is a diagram illustrating a battery module of a battery system according to embodiments of the present disclosure;

FIG. 4 is a diagram illustrating a cooling block of a battery system according to embodiments of the present disclosure;

FIG. 5 is a diagram illustrating a cooling block and a support member of a battery system according to embodiments of the present disclosure;

FIG. 6 is a diagram illustrating a support member of a battery system according to embodiments of the present disclosure;

FIG. 7 is an enlarged view of “F1” in the battery system reinforcement apparatus shown in FIG. 6;

FIG. 8 is a cross-sectional view illustrating the connection structure of a transverse member shown in FIG. 7;

FIG. 9 is an enlarged view of “F2” in the battery system reinforcement apparatus shown in FIG. 6;

FIG. 10 is a cross-sectional view illustrating the connection structure of the longitudinal member shown in FIG. 9; and

FIG. 11 is a diagram illustrating the connection structure of a front part of a case in the battery system according to embodiments of the present disclosure.

### DETAILED DESCRIPTION OF ILLUSTRATIVE EMBODIMENTS

Hereinafter, embodiments disclosed in the present specification will be described in detail with reference to the accompanying drawings, and the same or similar elements are given the same and similar reference numerals, so duplicate descriptions thereof will be omitted.

The terms “module” and “unit” used for the elements in the following description are given or interchangeably used in consideration of only the ease of writing the specification and do not have distinct meanings or roles by themselves.

In describing the embodiments disclosed in the present specification, when the detailed description of the relevant known technology is determined to unnecessarily obscure the gist of embodiments of the present disclosure, the detailed description may be omitted. Furthermore, the accompanying drawings are provided only for easy understanding of the embodiments disclosed in the present specification, the technical spirit disclosed herein is not limited to the accompanying drawings, and it should be understood that all changes, equivalents, or substitutes thereof are included in the spirit and scope of the present disclosure.

Terms including an ordinal number such as “first”, “second”, or the like may be used to describe various elements, but the elements are not limited to the terms. The above terms are used only for the purpose of distinguishing one element from another element.

In the case where an element is referred to as being “connected” or “coupled” to any other element, it should be understood that another element may be provided therebetween, as well as that the element may be directly connected or coupled to the other element. In contrast, in the case where an element is “directly connected” or “directly coupled” to any other element, it should be understood that no other element is present therebetween.

A singular expression may include a plural expression unless they are definitely different in a context.

As used herein, the expression “include” or “have” is intended to specify the existence of mentioned features, numbers, steps, operations, elements, components, or combinations thereof, and should be construed as not precluding the possible existence or addition of one or more other features, numbers, steps, operations, elements, components, or combinations thereof.

Hereinafter, a battery system reinforcement apparatus according to preferred embodiments of the present disclosure will be described with reference to the attached drawings.

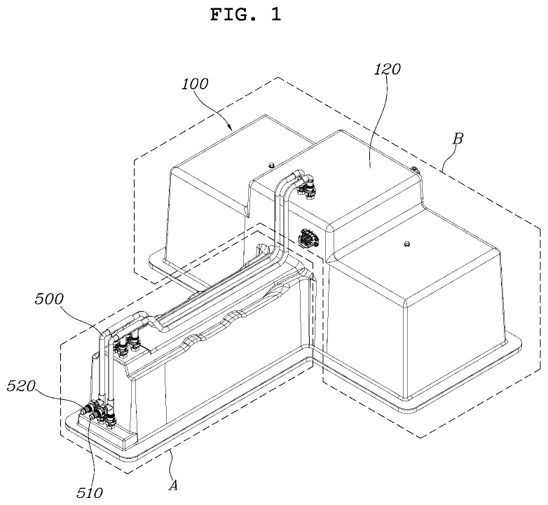

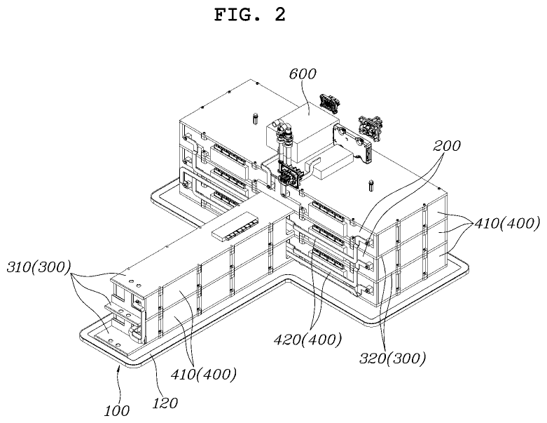

As shown in FIGS. 1 to 6, a battery system reinforcement apparatus according to embodiments of the present disclosure includes a case 100, a plurality of battery modules 200 mounted in multiple stages in the case 100, a plurality of cooling blocks 300 attached to the respective battery modules 200 and forming cooling passages D, and support members 400 provided in contact with the outer sides of the battery modules 200 and connected to the battery modules 200 or the cooling blocks 300 to support the battery modules 200 and the cooling blocks 300.

Embodiments of the present disclosure are configured to have battery modules 200 and cooling blocks 300 mounted in multiple stages inside the case 100, and the support members 400 are connected to the battery modules 200 and the cooling blocks 300 to support the battery modules 200 and the cooling blocks 300, thereby securing structural stability.

Electrical equipment 600 may be provided on the upper side of the uppermost battery module 200 among the plurality of battery modules 200, and the cooling block 300 may be attached to the outer surface of the electrical equipment 600.

The case 100 includes a lower case 110 and an upper case 120.

The lower case 110 has components including the battery modules 200 and the cooling blocks 300 provided therein, and the upper case 120 is coupled to the lower case 110 so as to seal the interior thereof.

The upper case 120 is formed to match the outer shape of the respective components, including the battery modules 200 and cooling blocks 300, to prevent unnecessary increase in size, and is coupled to the lower case 110 so as to seal the interior thereof, thereby protecting the battery modules 200 and the cooling blocks 300.

The lower case 110 and the upper case 120 may be made of aluminum or steel.

The cooling block 300 may be attached to the lower case 110, and the battery module 200 may be attached to the cooling block 300 so that the temperature of the battery module 200 may be adjusted through heat exchange.

A cooling passage D may be formed in the cooling block 300 so that a cooling medium may be circulated, and the cooling medium may be cooling water.

Embodiments of the present disclosure are configured such that the battery modules 200 and the cooling blocks 300 are mounted in multiple stages in the vertical direction. In other words, since the battery system is configured in multiple stages in the vertical direction, instead of being configured in a single stage, the battery system may be installed in various positions, not limited to the lower portion of the mobility, in consideration of the indoor space of the occupants.

For example, the battery system may be mounted on the front using the central tunnel portion in the center of the mobility or may be mounted on the rear using the space behind the driver's seat.

As described above, embodiments of the present disclosure are configured to include a plurality of battery modules 200 and cooling blocks 300 mounted in multiple stages in the vertical direction, thereby configuring the battery system as an atypical package.

In particular, the support members 400 are provided to be in contact with the outer sides of the battery modules 200, and the support members 400 are connected to the battery modules 200 or the cooling blocks 300 to support the battery modules 200 and the cooling blocks 300.

The support member 400 may be formed to extend along the outer side of the battery module 200 and may be connected to the battery module 200 or the cooling block 300 to reinforce the structural rigidity of the battery module 200 and the cooling block 300. As a result, the surface pressure of the cells C inside the battery module 200 may be maintained, and the connection state between the battery module 200 and the coupling of the battery module 200 and the cooling block 300 may be stabilized, thereby obtaining effects of maintaining the cooling state, reducing vibration, securing structural rigidity, and the like.

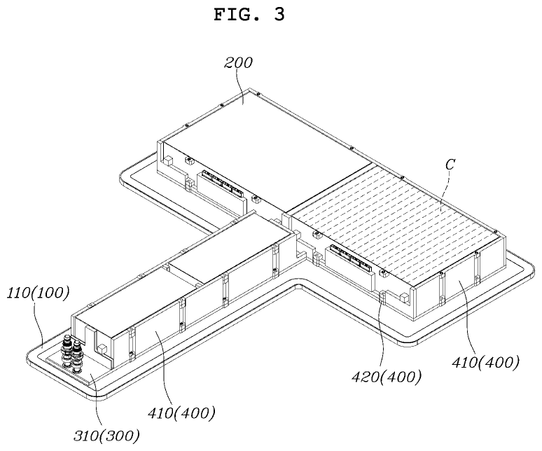

Meanwhile, as shown in FIG. 3, the battery module 200 may include a plurality of cells C, and the plurality of cells C may be stacked to be arranged in the transverse direction while standing in the longitudinal direction.

As described above, the battery module 200 includes a plurality of cells C, and the respective cells C are stacked to be arranged in the transverse direction while standing in the longitudinal direction, so that cooling may be effectively performed by the cooling blocks 300 provided on the upper and lower sides of the battery module 200.

In addition, since the outer side of the battery module 200 is surrounded by the support member 400, the surface pressure of the cells C is maintained, thereby preventing expansion of the respective cells C.

Meanwhile, as shown in FIG. 1, the case 100 may be configured as a front part A and a rear part B, and the front part A and the rear part B may be connected at right angles to form a T shape.

Accordingly, the lower case 110 and the upper case 120 may secure space on both sides of the front part A, thereby securing interior space on both sides of the front part A for other components to be provided. In addition, since the rear part B is arranged to be perpendicular to the front part A, even if the size of the battery module 200 increases, it may be accommodated in the rear part B.

In particular, since the lower case 110 and the upper case 120 are configured to intersect at a right angle, the battery system may be disposed at the front using the central tunnel portion of the mobility.

Here, the cooling block 300 may include a first cooling block 310 provided in the front part A of the case 100 and a second cooling block 320 provided in the rear part B of the case 100, and the first cooling block 310 and the second cooling block 320 may share a cooling passage D.

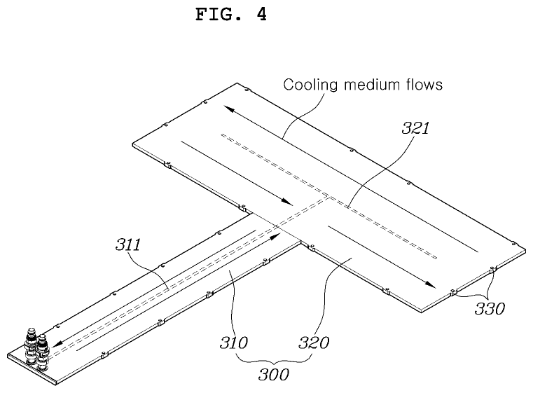

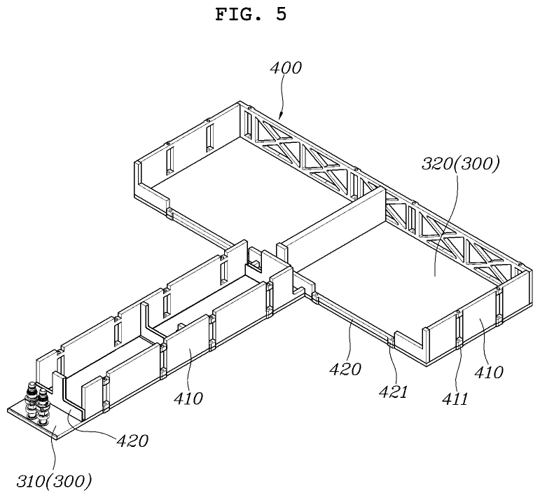

As shown in FIGS. 4 and 5, the cooling block 300 may include a first cooling block 310 and a second cooling block 320, and the first cooling block 310 may be provided in the front part A of the case 100, and the second cooling block 320 may be provided in the rear part B of the case 100, so that the temperature of the respective battery modules 200 provided in the front part A and rear part B of the case 100 may be managed.

Here, the first cooling block 310 and the second cooling block 320 are connected to share a cooling passage D, thereby simplifying the line for supplying the cooling medium. That is, if the cooling medium is supplied to any one cooling block 300 of the first cooling block 310 and the second cooling block 320, the cooling medium may circulate through the respective cooling blocks 300.

Specifically, embodiments of the present disclosure further include a cooling hose 500 having an inlet 510 and an outlet 520 for circulation of the cooling medium. This cooling hose 500 may be configured such that the cooling medium circulates therethrough by an external electric water pump, reservoir, heater, chiller, and the like, thereby controlling the temperature of the cooling medium. The cooling medium may be cooling water.

The inlet 510 and the outlet 520 of the cooling hose 500 are connected to the first cooling block 310, and a first partition 311 is formed such that the cooling passage D is divided to the cooling passage leading to the inlet 510 and the cooling passage leading to the outlet 520.

In addition, a second partition 321 is formed in the second cooling block 320 to be matched to the first partition 311, so that the cooling medium flowing in from the first cooling block 310 is guided by the second partition 321 to circulate throughout the second cooling block 320.

Through this, the cooling medium flowing through the cooling hose 500 flows into the first cooling block 310, circulates through the second cooling block 320, and then flows out through the first cooling block 310.

The first partition 311 of the first cooling block 310 may extend in the front and rear directions to separate the inlet 510 and the outlet 520, and the second partition 321 of the second cooling block 320 may be connected to the first partition 311 to extend laterally, forming a T shape.

Accordingly, the cooling medium flowing in through the inlet 510 of the cooling hose 500 may circulate throughout the entire first cooling block 310 and the entire second cooling block 320 and then flow out through the outlet 520, thereby securing temperature management performance of the battery module 200 through the first cooling block 310 and the second cooling block 320.

In addition, even if the case 100 is formed in a T shape, a smooth flow of the cooling medium may be secured while sharing the cooling medium through the arrangement of the first cooling block 310 and the second cooling block 320 and the partitions thereof.

Meanwhile, the support members 400 according to embodiments of the present disclosure may be configured as longitudinal members 410 and transverse members 420, and the longitudinal members 410 and the transverse members 420 may be arranged to surround the outer side of the battery module 200.

As shown in FIGS. 5 to 11, the support member 400 is formed to surround the outer side of each battery module 200 through the longitudinal member 410 and the transverse member 420.

Here, the longitudinal member 410 is formed to cover the battery module 200 in the longitudinal direction, and the transverse member 420 is formed to extend in the transverse direction along the outer side of the battery module 200.

The longitudinal members 410 and the transverse members 420 above are connected to each other and surround the outer side of the battery module 200.

The longitudinal members 410 may be positioned to face in a direction in which the cells C of the battery module 200 are stacked, and the transverse members 420 may be formed to extend along the direction in which the cells C of the battery module 200 are stacked.

Accordingly, the battery module 200 may maintain surface pressure in the direction in which the cells C of the battery module 200 are stacked by the longitudinal members 410, and the respective longitudinal members 410 may be connected by the transverse members 420 to form a stable support structure.

In addition, as the longitudinal members 410 and the transverse members 420 are connected to the battery module 200 and the cooling block 300, the coupling rigidity of the battery module 200 and the cooling block 300 is secured.

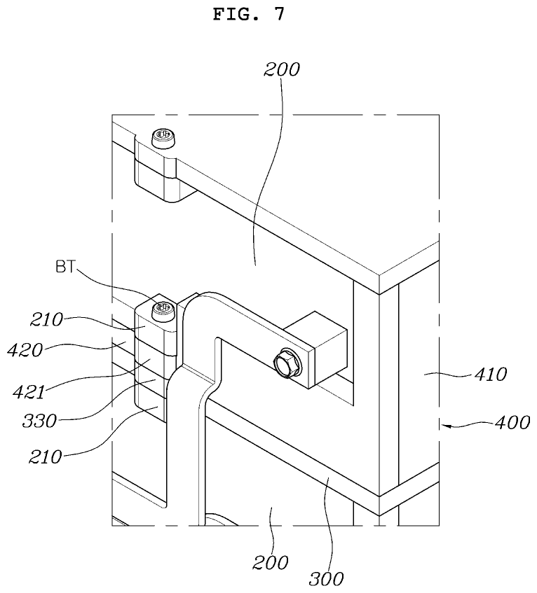

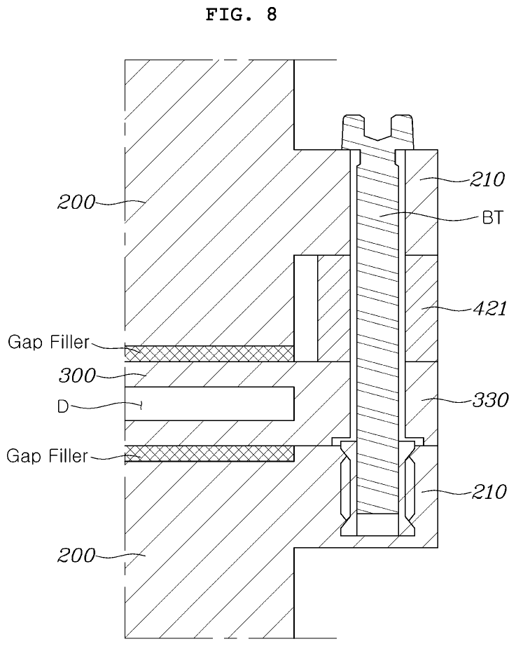

Specifically, as shown in FIGS. 7 to 8, the transverse member 420 may extend in the lateral direction on the outer surface of the battery module 200 and have a first fastening portion 421 formed to be connected to the battery module 200 and the cooling block 300.

In addition, the battery module 200 may have a first connection portion 210 matching the first fastening portion 421, which is formed on the outer surface thereof, and the cooling block 300 may have a first coupling portion 330 matching the first fastening portion 421, which is formed on the outer surface thereof, and they may be coupled to each other by a fastening member BT in the state in which the first fastening portion 421 of the transverse member 420 matches the first connection portion 210 and the first coupling portion 330.

The first fastening portion 421 of the transverse member 420, the first connection portion 210 of the battery module 200, and the first coupling portion 330 of the cooling block 300 have a protruding shape, and the battery module 200, the cooling block 300, and the transverse member 420 match each other in the longitudinal direction when assembled.

The first fastening portion 421, the first connection portion 210, and the first coupling portion 330 may be fastened by the fastening member BT passing therethrough in the longitudinal direction, so that the transverse member 420, the battery module 200, and the cooling block 300 may be coupled through the fastening member BT. The fastening member BT may be configured as a bolt.

In addition, since embodiments of the present disclosure are configured such that the battery modules 200 and the cooling blocks 300 are mounted in multiple stages, the battery modules 200 may be provided on the upper and lower sides of one cooling block 300.

Accordingly, as shown in FIG. 7, based on the cooling block 300 in the center, the first connection portion 210 of the upper battery module 200, the first fastening portion 421 of the transverse member 420, the first coupling portion 330 of the cooling block 300, and the first connection portion 210 of the lower battery module 200 may match in the longitudinal direction and then be coupled to each other through the fastening member BT.

Thus, in mounting the battery modules 200 and the cooling blocks 300 in multiple stages, the battery modules 200 and the cooling blocks 300 may be coupled to each other through the support member 400 to obtain structural stability.

Here, a plurality of first fastening portions 421, a plurality of first connection portions 210, and a plurality of first coupling portions 330 may be configured to be spaced apart from each other at equal intervals. As the plurality of first fastening portions 421, the plurality of first connection portions 210, and the plurality of first coupling portions 330 are configured, the first fastening portions 421, the first connection portions 210, and the first coupling portions 330 matching each other may be coupled through the fastening member BT, thereby increasing the coupling rigidity of the battery module 200, the cooling block 300, and the transverse member 420 of the support member 400.

In addition, since the first fastening portions 421, the first connection portions 210, and the first coupling portions 330 are spaced apart from each other at equal intervals, local stress may be prevented from being concentrated on any one part of the battery module 200, the cooling block 300, and the transverse member 420 of the support member 400, thereby providing uniform support.

Meanwhile, the longitudinal member 410 may be divided into a plurality of parts and formed to extend along the outer surface of the battery module 200 in the longitudinal direction, and the respective longitudinal members 410 may be connected to each other by a second fastening portion 411.

As shown in FIG. 5, a plurality of longitudinal members 410 may be configured, and the respective longitudinal members 410 may be formed to match the longitudinal length of the battery module 200, so that the plurality of longitudinal members 410 may cover the outer surfaces of the battery modules 200.

The plurality of longitudinal members 410 may have a second fastening portion 411 formed thereon, and the respective longitudinal members 410 may be connected through the second fastening portions 411 so as to be arranged along the outer surfaces of the battery modules 200.

As described above, the support member 400 may be disposed such that the longitudinal member 410 faces in the direction in which the cells C of the battery module 200 are stacked, and the longitudinal member 410 may be formed to secure a contact area with respect to the battery module 200, thereby maintaining the surface pressure of the cell C.

Meanwhile, the cooling block 300 may have a second coupling portion 340 formed on the outer surface thereof to match the second fastening portion 411, and the second fastening portion 411 of the longitudinal member 410 may match the second coupling portion 340 and then may be coupled to each other through the fastening member BT.

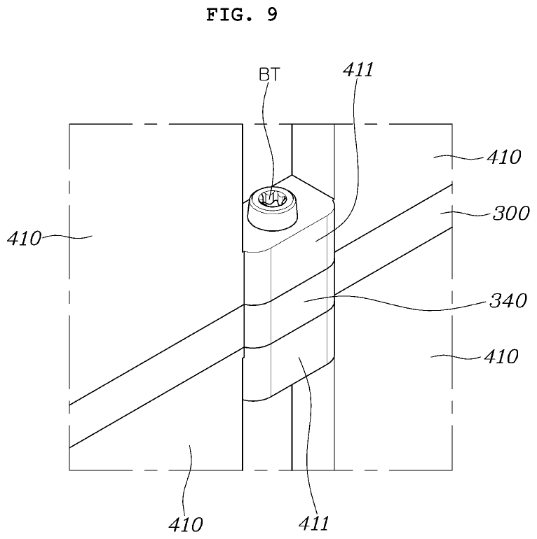

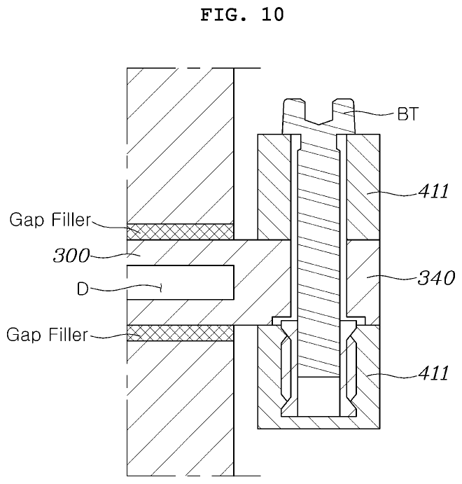

As shown in FIGS. 9 to 10, the second fastening portion 411 of the longitudinal member 410 and the second coupling portion 340 of the cooling block 300 have a protruding shape, and the battery module 200, the cooling block 300, and the support member 400 match each other in the longitudinal direction when assembled.

Here, the second fastening portion 411 and the second coupling portion 340 may be fastened by the fastening member BT passing therethrough in the longitudinal direction, so that the longitudinal member 410 of the support member 400 and the cooling block 300 may be coupled through the fastening member BT. The fastening member BT may be configured as a bolt.

Accordingly, the position of the support member 400 is fixed as the longitudinal member 410 is connected to the cooling block 300, thereby obtaining structural stabilization.

Meanwhile, the second fastening portions 411 may be formed at the upper and lower ends of the longitudinal member 410, respectively, and in the case of different support members 400 provided on the upper and lower sides of the cooling block 300, the second fastening portions 411 of each longitudinal member 410 may be coupled to the second coupling portion 340 of the cooling block 300 through the fastening member BT.

In embodiments of the present disclosure, the battery modules 200 and the cooling blocks 300 are configured to be mounted in multiple stages, the battery modules 200 are provided on the upper and lower sides of one cooling block 300, and each battery module 200 is provided with a longitudinal member 410 of the support member 400.

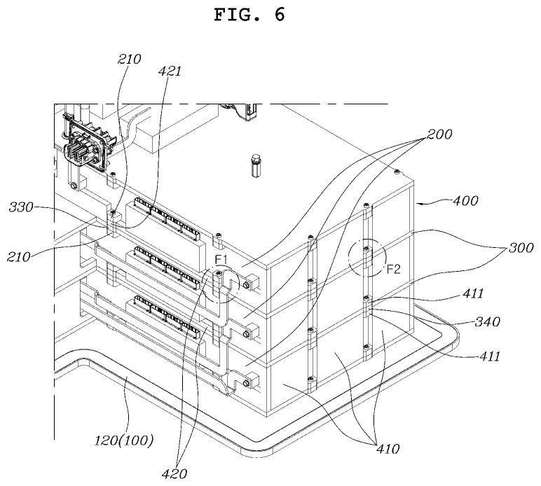

Accordingly, as shown in FIGS. 6 and 9, based on the cooling block 300 in the center, the second fastening portion 411 of the longitudinal member 410 corresponding to the upper battery module 200, the second coupling portion 340 of the cooling block 300, and the second fastening portion 411 of the longitudinal member 410 corresponding to the lower battery module 200 may match in the longitudinal direction and then may be coupled to each other through the fastening member BT.

Accordingly, the plurality of support members 400 may be connected to the cooling blocks 300 disposed between the battery modules 200, thereby obtaining structural stabilization.

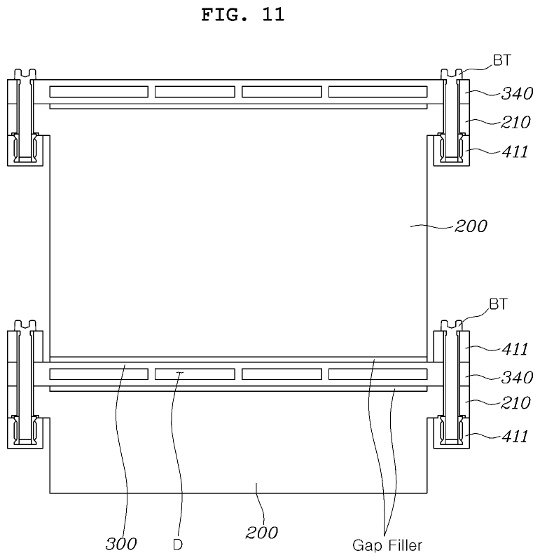

Although embodiments of the present disclosure have been described above as a structure in which each battery module 200, cooling block 300, and support member 400 are connected in the rear part B of the case 100 shown in FIG. 6, each battery module 200, cooling block 300, and support member 400 may also be connected in the same structure in the front part A of the case 100 shown in FIG. 11.

The battery system reinforcement apparatus in the structure described above may have battery modules 200 and cooling blocks 300 mounted in multiple stages, thereby diversifying the installation locations of the battery system, increasing structural rigidity by reinforcing overall rigidity, and ensuring battery stability by maintaining surface pressure of battery cells C.

Damage due to external loads such as vibration and compression applied to the battery module 200 is prevented by ensuring the structural rigidity and coupling of the battery system as described above.

Although embodiments of the present disclosure have been described and illustrated in conjunction with particular embodiments thereof, it will be apparent to those skilled in the art that various improvements and modifications may be made to the embodiments of the present disclosure without departing from the technical idea of the present disclosure defined by the appended claims.

What is claimed is:

1. A battery system reinforcement apparatus, the apparatus comprising:
a case;
a plurality of battery modules mounted in multiple stages in the case;
a plurality of cooling blocks respectively attached to the battery modules and defining a cooling passage; and
a support member disposed in contact with an outer side of the battery modules and connected to the battery modules or the cooling blocks to support the battery modules and the cooling blocks.

2. The apparatus of claim 1, wherein:
the case comprises a lower case and an upper case;
the battery modules and the cooling blocks are mounted in the lower case; and
the upper case covers the battery modules and the cooling blocks and is coupled to the lower case.

3. The apparatus of claim 1, wherein each of the battery modules comprises a plurality of cells, the plurality of cells being stacked to be arranged in a transverse direction while standing in a longitudinal direction.

4. The apparatus of claim 1, wherein the case includes a front part and a rear part connected at right angles to define a T shape.

5. The apparatus of claim 4, wherein:
the cooling blocks comprise a first cooling block disposed in the front part of the case and a second cooling block disposed in the rear part of the case; and
the first cooling block and the second cooling block share the cooling passage.

6. The apparatus of claim 5, further comprising a cooling hose having an inlet and an outlet for circulation of a cooling medium.

7. The apparatus of claim 6, wherein:
the first cooling block is connected to the inlet and the outlet of the cooling hose and comprises a first partition dividing the cooling passage into a first cooling passage leading to the inlet and a second cooling passage leading to the outlet; and
a second partition is disposed in the second cooling block to be matched to the first partition such that the cooling medium flowing in from the first cooling block is guided by the second partition to circulate throughout the second cooling block.

8. A battery system reinforcement apparatus, the apparatus comprising:
a case;
a plurality of battery modules mounted in multiple stages in the case;
a plurality of cooling blocks respectively attached to the battery modules and defining a cooling passage; and
a support member disposed in contact with an outer side of the battery modules and connected to the battery modules or the cooling blocks to support the battery modules and the cooling blocks, wherein the support member comprises a longitudinal member and a transverse member, the longitudinal member and the transverse member being disposed to surround the outer side of the battery modules.

9. The apparatus of claim 8, wherein the transverse member extends in a lateral direction from an outer surface of the battery modules and comprises a first fastening portion connected to the battery modules and the cooling blocks.

10. The apparatus of claim 9, wherein:
each of the battery modules comprises a first connection portion disposed on the outer surface thereof so as to match the first fastening portion;
each of the cooling blocks comprises a first coupling portion disposed on an outer surface thereof so as to match the first fastening portion; and
the first fastening portion of the transverse member, the first connection portion, and the first coupling portion are coupled to each other through a fastening member while matching each other.

11. The apparatus of claim 10, wherein a plurality of the first fastening portions, a plurality of the first connection portions, and a plurality of the first coupling portions are configured to be spaced apart from each other at equal intervals.

12. The apparatus of claim 8, wherein:
the longitudinal member is divided into a plurality of parts and extends along an outer surface of the battery modules in a longitudinal direction; and
the parts of the longitudinal member are connected to each other by a second fastening portion.

13. The apparatus of claim 12, wherein:
each of the cooling blocks comprises a second coupling portion disposed on an outer surface thereof so as to match the second fastening portion; and
the second fastening portion of the longitudinal member and the second coupling portion are coupled to each other through a fastening member while matching each other.

14. The apparatus of claim 13, wherein:
the second fastening portion is disposed at an upper end and at a lower end of the longitudinal member; and
in an arrangement in which different support members are disposed on upper and lower sides of the cooling blocks, the second fastening portions of each longitudinal member are coupled to the second coupling portions of the cooling blocks through the fastening member.

15. A battery system reinforcement apparatus, the apparatus comprising:
a case comprising an upper case and a lower case;
a plurality of battery modules mounted in multiple stages in the lower case;
a plurality of cooling blocks respectively attached to the battery modules and defining a cooling passage, the plurality of cooling blocks comprising a first cooling block disposed in a front part of the case and a second cooling block disposed in a rear part of the case, the first cooling block and the second cooling block sharing the cooling passage; and
a support member disposed in contact with an outer side of the battery modules and connected to the battery modules or the cooling blocks to support the battery modules and the cooling blocks.

16. The apparatus of claim 15, wherein:
the cooling blocks are mounted in the lower case; and
the upper case covers the battery modules and the cooling blocks and is coupled to the lower case.

17. The apparatus of claim 15, wherein each of the battery modules comprises a plurality of cells, the plurality of cells being stacked to be arranged in a transverse direction while standing in a longitudinal direction.

18. The apparatus of claim 17, wherein the front part and the rear part of the case are connected at right angles to define a T shape.

19. The apparatus of claim 15, further comprising a cooling hose having an inlet and an outlet for circulation of a cooling medium.

20. The apparatus of claim 19, wherein:
the first cooling block is connected to the inlet and the outlet of the cooling hose and comprises a first partition dividing the cooling passage into a first cooling passage leading to the inlet and a second cooling passage leading to the outlet; and
a second partition is disposed in the second cooling block to be matched to the first partition such that the cooling medium flowing in from the first cooling block is guided by the second partition to circulate throughout the second cooling block.
